(19) United States
(12) Patent Application Publication
(10) Pub. No.: US 2015/0228469 A1
(43) Pub. Date: Aug. 13, 2015

(54) QUADRUPOLE MASS SPECTROMETRY APPARATUS

(71) Applicant: SHIMADZU CORPORATION, Kyoto-shi (JP)

(72) Inventor: Shiro MIZUTANI, Kyoto (JP)

(73) Assignee: SHIMADZU CORPORATION, Kyoto-shi (JP)

(21) Appl. No.: 14/178,404

(22) Filed: Feb. 12, 2014

(51) Int. Cl. H01J 49/42; H01J 49/02

(52) U.S. Cl. CPC H01J 49/4215; H01J 49/022

(57) ABSTRACT

A quadrupole mass spectrometry apparatus including a quadrupole power supply unit, in which the frequency of the high frequency voltage produced by a high frequency power supply is made switchable, and variable capacitors are provided in parallel with the floating capacitance of a quadrupole mass filter. In a high sensitivity mode which prioritizes sensitivity, the frequency of the high frequency voltage is made higher than in a high mass mode which prioritizes width of mass range, and the capacitance values of variable capacitors are increased. Increasing the capacitance value forming an LC resonant circuit causes the frequency based on the LC resonance conditions to rise, making it possible to cause LC resonance of the high frequency voltage with a higher frequency and to increase the amplitude thereof.

The entire contents of Japanese Patent Publication No. 2013-097957 to the same inventors, published May 20, 2013, are incorporated herein by reference.

### TECHNICAL FIELD

The present invention relates to a quadrupole mass spectrometry apparatus using a quadrupole mass filter as a mass separator which separates ions according to their mass-charge ratio m/z; more specifically, the invention relates to a quadrupole driving unit which applies a driving voltage to the quadrupole mass filter.

### BACKGROUND ART

A quadrupole mass spectrometry apparatus is a mass spectrometry apparatus which uses a quadrupole mass filter to separate and detect ions according to mass-charge ratio. FIG. 4 is a simplified diagram of a common quadrupole mass spectrometry apparatus.

Ions generated from the sample in the ion source 1 pass through an unillustrated ion optical system such as an ion guide, etc., and are introduced into a quadrupole mass filter 2 comprising four substantially circular cylindrical rods 2a, 2b, 2c and 2d. A voltage ±(U+V·cos ωt) in which a high frequency voltage ±V·cos ωt is superimposed with a direct current voltage ±U is applied from a quadrupole power supply unit 4 to the four rod electrodes 2a through 2d arranged in parallel so as to surround the ion optical axis C, and only ions having a specific mass-charge ratio corresponding to the applied voltage pass selectively through the quadrupole mass filter 2, while ions having other mass-charge ratios are dispersed along the way. An ion detector 3 detects ions which have passed through the quadrupole mass filter 2, and outputs a detection signal with an intensity corresponding to the quantity of such ions.

To perform scanning measurement across a predetermined mass (strictly speaking, mass-charge ratio) range, control unit 5 controls the quadrupole power supply unit 4 so as to change the amplitude value V of the high frequency voltage V·cos ωt and the direct current voltage value U while maintaining a constant relationship between them. As a result, the mass-charge ratio of ions passing through the quadrupole mass filter 2 is scanned over a predetermined range. Data processing unit 6 generates a mass spectrum, with mass-charge ratio on the horizontal axis and ion intensity on the vertical axis, based on the detection signals successively obtained by the ion detector 3 during scanning.

In a common quadrupole mass spectrometry apparatus, the upper limit of the measured mass range is about m/z 2,000, which can be said to be essentially adequate for qualitative analysis of common compounds. However, in recent years, the need for trace analysis has increased, and the demand for improvement of detection sensitivity is very strong. Generally, the ionic current I obtained from ions which pass through the quadrupole mass filter 2 and reach the ion detector 3 and the frequency ω of the high frequency voltage applied to the quadrupole mass filter 2 have the relationship shown in the following formula (1).

I∝r₀²·ω/(M/ΔM) (1)

Here, r0 is the radius of the inscribed circle of rod electrodes 2a through 2d, and M/ΔM is the mass resolution. Namely, according to formula (1), the detected ion intensity increases when the frequency ω of the high frequency voltage applied to the quadrupole mass filter 2 become higher. Thus, it can be said that one way to increase the detection sensitivity in a quadrupole mass spectrometry apparatus is to raise the frequency of the high frequency voltage applied to the quadrupole mass filter 2.

However, if the frequency of the high frequency voltage applied to the quadrupole mass filter 2 is raised, there will be the following problem.

It is known that the conditions for the stable confinement of ions by the quadrupole electric field formed in the space surrounded by the four rod electrodes 2a through 2d as shown in FIG. 4 can be expressed by the Mathieu equation as shown under formula (2) below.

au=ax=−ay=4eU/(mω²r₀²)

qu=qx=−qy=2eU/(mω²r₀²) (2)

Here, e is the quantum of electricity and m is ion mass. According to formula (2), it can be seen that when the frequency ω of the high frequency voltage applied to the rod electrodes 2a through 2d changes, the voltage (amplitude) for optimally confining ions having a given mass-charge ratio needs to undergo a change which is the square of the frequency change. Namely, this means that, for ions having the same mass-charge ratio, if the frequency ω is raised, the amplitude of the applied voltage also needs to be increased. However, with a common quadrupole power supply unit 4, it is difficult to greatly increase the amplitude of the high frequency voltage when its frequency is changed.

FIG. 5 is a simplified block diagram of a common quadrupole power supply unit 4 (see Patent Literature 1, etc.). This quadrupole power supply unit 4 comprises a high frequency power supply 41, a transformer 42, a positive pole direct current power supply 43, negative pole direct current power supply 44, and inductors (coils) 45, 46 each having an inductance L. The high frequency voltage outputted from the high frequency power supply 41 is superimposed onto the positive and negative direct current voltage outputted from the positive pole direct current power supply 43 and negative pole direct current power supply 44 via transformer 42. Rod electrodes 2a through 2d have an interelectrode, etc. floating capacitance, and at the output stage of the quadrupole power supply unit 4, an LC resonant circuit is formed by capacitance C due to that floating capacitance and the inductance L of inductor 45 or 46. The voltage in which the high frequency voltage and direct current voltage have been superimposed in the secondary coil of transformer 42 as described above resonates in the LC resonant circuit, and its amplitude is amplified and applied to the rod electrodes 2a through 2d.

The conditions of resonance in the aforesaid LC resonant circuit are f=1/{2π√}LC)}. Thus, when the frequency ω of the high frequency voltage produced in the high frequency power supply 41 is changed, the LC resonant circuit cannot remain in tune, and it becomes impossible to apply a high frequency voltage of adequate amplitude to allow ions to pass through to the rod electrodes 2a through 2d.

### PRIOR ART LITERATURES

### Patent Literatures

(Patent literature 1) International Patent Publication No. 2010/023706 pamphlet

### SUMMARY OF THE INVENTION

The present invention was made to resolve the problem described above, its purpose being to provide a quadrupole mass spectrometry apparatus capable of selectively executing mass spectrometry with narrow measured mass range but high detection sensitivity, and conversely, mass spectrometry with not particularly high detection sensitivity but a wide measured mass range, in accordance with the purpose of analysis, etc.

The present invention, made to resolve the aforementioned problem, is a quadrupole mass spectrometry apparatus comprising a quadrupole mass filter comprising a plurality of electrodes; and a quadrupole driving unit which contains a high frequency power supply unit and an inductor which increases the amplitude of the high frequency voltage supplied from said high frequency power supply unit and forms a resonant circuit along with the floating capacitance between the electrodes of said quadrupole mass filter, so as to apply, to the electrodes of said quadrupole mass filter, a predetermined voltage in which a high frequency voltage and direct current voltage are superimposed so that ions having a specific mass-charge ratio will selectively pass through said quadrupole mass filter,

characterized in that the output high frequency voltage of said high frequency power supply unit has a frequency which is variable or switchable between a plurality of frequencies,

and said quadrupole mass spectrometry apparatus further comprises:

a capacitor unit with a capacitance which is variable or switchable between a plurality of capacitances, connected in parallel with the floating capacitance between the electrodes of said quadrupole mass filter; and

a controller which controls said high frequency power supply unit so as to change or switch the frequency of the high frequency voltage produced by said high frequency power supply unit, and changes or switches the capacitance of said capacitor unit accordingly.

In the quadrupole mass spectrometry apparatus according to the present invention, when the capacitance of the capacitor unit is changed or switched, the resonant frequency of the resonant circuit formed by that capacitance and the inductance of the inductor changes. Therefore, even when the frequency of the high frequency voltage generated in the high frequency power supply unit is switched, it is possible to bring the frequency of the high frequency voltage near the resonance point by switching the resonant frequency of the resonant circuit along with the aforesaid switching, making it possible to apply a high frequency voltage of large amplitude to the electrodes of the quadrupole mass filter.

If the frequency of the high frequency voltage in the quadrupole mass spectrometry apparatus is raised as described above, the detection sensitivity increases. Namely, as one preferable mode of embodiment of the quadrupole mass spectrometry apparatus according to the present invention, a configuration can be employed wherein the frequency of the high frequency voltage produced by the high frequency power supply unit can be switched between at least two levels, and said controller, when in a sensitivity priority mode in which height of detection sensitivity is prioritized over width of measured mass range, selects a state in which the frequency of the high frequency voltage produced by said high frequency power supply unit is relatively high, and when in mass range priority mode in which width of measured mass range is prioritized over height of detection sensitivity, selects a state in which the frequency of the high frequency voltage produced by said high frequency power supply unit is relatively low. Based on this, it is possible to perform both high sensitivity measurement and measurement of a wide mass range according to the purpose of analysis, etc., using a single apparatus.

Various sorts of configuration and structure are possible for changing or switching the capacity in the capacitor unit. For example, a configuration is possible wherein a capacitance is formed between a pair of electrodes plates arranged opposite each other, and the surface area of the facing electrode plates is changed by rotating or moving one of the electrode plates, or the capacitance is changed by changing the distance between the two electrode plates. By employing a configuration in which the rotation or movement of electrode plates as described above is carried out by means of a driving mechanism such as a motor, the capacitance can be arbitrarily changed through electric driving.

By using a capacitor unit which allows continuously changing the capacitance in this manner, it is possible not just to switch the capacitance in response to switching of the frequency of the high frequency voltage for switching of the measurement mode as described above, but to also finely adjust the capacitance instead of finely adjusting the frequency of the high frequency voltage produced by the high frequency power supply unit for the purpose of adjustment of the peak shape, adjustment of the mass axis, etc. on the mass spectrum. As a result, it is possible to simplify the apparatus configuration and control (specifically, the control program).

Furthermore, the capacitor unit can be made to switch between a plurality of predetermined capacitances using switching means such as semiconductor switches, electromagnetic relays, mechanical switches, etc.

In principle, it is also possible to change the resonant frequency by varying the inductance of the inductor forming the resonant circuit instead of the capacitor, but unlike a capacitor, the fabrication of a variable inductor is difficult, and particularly in cases where the inductance is to be changed greatly, there is practically no method that can be used except for switching the contacts of the coil. In this respect, a variable capacitor has the advantage of allowing the capacitance to be changed greatly using a relatively simple configuration and structure.

With the quadrupole mass spectrometry apparatus according to the present invention, it becomes possible for a user to freely select and perform high sensitivity measurement with a somewhat narrow measured mass range, or measurement across a wide mass range but with somewhat inferior measurement sensitivity, according to the purpose of analysis, etc., using a single apparatus.

### BRIEF DESCRIPTION OF THE DRAWINGS

FIG. 1 A simplified block diagram of a quadrupole power supply unit in a quadrupole mass spectrometry apparatus constituting a first example of embodiment of the present invention.

FIG. 2 A simplified block diagram of a quadrupole power supply unit in a quadrupole mass spectrometry apparatus constituting a second example of embodiment of the present invention.

FIG. 3 A drawing showing a comparative example of measurement of signal strength when the frequency of high frequency voltage is switched between 1.2 MHz and 1.5 MHz.

FIG. 4 A simplified diagram of a common quadrupole mass spectrometry apparatus.

FIG. 5 A simplified block diagram of a conventional quadrupole power supply unit.

### DETAILED DESCRIPTION OF THE EXEMPLARY EMBODIMENTS

A quadrupole mass spectrometry apparatus constituting an example of embodiment of the present invention (hereinafter referred to as “first example of embodiment”) will be described in detail with reference to the appended drawings.

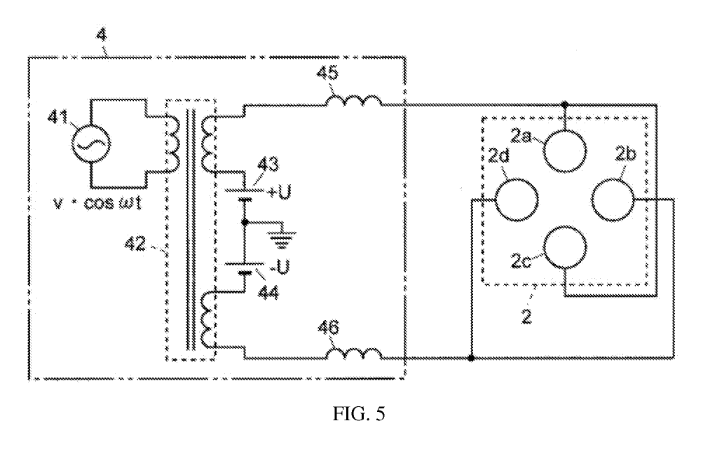

The overall configuration of the quadrupole mass spectrometry apparatus of the first example of embodiment is the same as that of the conventional apparatus explained using FIG. 4, so description thereof will be omitted. The distinguishing characteristics of the quadrupole mass spectrometry apparatus of the present example of embodiment lie in the configuration of the quadrupole power supply unit 4. FIG. 1 is a block diagram of the quadrupole power supply unit 4 in the quadrupole mass spectrometry apparatus of the present example of embodiment. In the drawing, components which are the same as those already explained in FIG. 5 are assigned the same symbols, and detailed description thereof will be omitted.

The quadrupole power supply unit 4 in the first example of embodiment comprises a transformer 42, positive pole direct current power supply 43, negative pole direct current power supply 44, inductors 45 and 46, as well as a variable-frequency high frequency power supply 401, variable-capacity variable capacitors 402 and 403, and drive sources 404 and 405 which perform mechanical driving for changing the capacity of the variable capacitors 402 and 403. Variable capacitor 402 is connected in parallel to the floating capacitance formed by rod electrodes 2a, 2c, etc. connected to one end of inductor 45, and variable capacitor 403 is connected in parallel to the variable capacitance formed by rod electrodes 2b, 2d, etc. connected to one end of inductor 46.

For example, these variable capacitors 402 and 403 can have a structure in which a capacitance is formed between a pair of facing electrode plates, and the capacitance is changed by changing the surface area of the opposed portion of the two electrode plates by rotating one of the electrode plates in relation to the other electrode plate while maintaining the distance between the two electrode plates. In this case, drive sources 404 and 405 comprise a motor, a speed reduction mechanism, etc., and rotate one of the electrode plates as described above. The frequency of the high frequency power supply 401 and the capacitance of the variable capacitors 402, 403 are both changed according to control signals from control unit 5.

A specific example of the quadrupole power supply unit 4 in the first example of embodiment will be presented to explain the operation. In the quadrupole mass spectrometry apparatus of this first example of embodiment, there is provided, in terms of measurement modes, a high sensitivity mode which prioritizes measurement sensitivity over measured mass range, and a high mass mode which prioritizes width of measured mass range over measurement sensitivity, and the user can select either of the measurement modes according to the purpose of measurement, etc., using an unillustrated control panel unit. The frequency of the high frequency power supply 401 can be switched to one of two settings: 1.2 MHz or 1.5 MHz. Furthermore, the variable capacitors 402, 403 can basically be switched to one of two settings, 0 pF or 51 pF, but the capacitance can be adjusted within a predetermined range from 0 pF and 51 pF for the purpose of fine adjustment. It will be assumed that the capacitance including the floating capacitance of the rod electrodes 2a through 2d of the quadrupole mass filter 2 is approximately 90 pF, and the inductance of the inductors 45, 46 is 125 pH.

When high mass mode is selected and analysis is initiated, the control unit 5 controls high frequency power supply 401 so as to set the frequency of the high frequency voltage to 1.2 Mhz, and controls the drive sources 404, 405 so that the capacitances of variable capacitors 402, 403 become 51 pF. Here, the total capacitance connected in series to inductor 45 (or 46) is the sum of the floating capacitance of rod electrodes 2a through 2d and the capacitance of the variable capacitor 402 (or 403), and is thus 51+90=141 pF. Therefore, the conditions of resonance in the LC resonant circuit will be

f=1/{2π√(LC)}=1/{2π√(125 μH·141 pF)}=1.2 MHz,

making it possible to obtain a large amplitude by resonating the high frequency voltage supplied from the high frequency power supply 401, which has a frequency of 1.2 MHz.

Furthermore, when high sensitivity mode is selected and analysis is initiated, the control unit 5 controls the high frequency power supply 401 so as to set the frequency of the high frequency voltage to 1.5 MHz, and controls the drive sources 404, 405 so that the capacitances of the variable capacitors 402, 403 become 0 pF. Here, the total capacitance connected in series to inductor 45 (or 46) is only the floating capacitance of the rod electrodes 2a through 2d, and is thus 90 pF. Therefore, the conditions of resonance in the LC resonant circuit will be

f=1/{2π√(LC)}=1/{2π(125 μH·90 pF)}=1.5 MHz,

making it possible to obtain a large amplitude by resonating the high frequency voltage supplied from the high frequency power supply 401, which has a frequency of 1.5 MHz.

Even when the frequency of the high frequency voltage is changed in accordance with the measurement mode, as described above, a high frequency voltage of adequate amplitude to cause the high frequency voltage to resonate in the LC resonant circuit can be applied to the rod electrodes 2a through 2d. When the frequency of the high frequency voltage is 1.2 MHz, the amplitude of the high frequency voltage for suitable containment of ions at m/z=2,000 is 3,200 V (0-peak). On the other hand, when the frequency of the high frequency voltage is 1.5 MHz, the amplitude of the high frequency voltage for suitable containment of ions even at m/z=1,500 is 3,750 V (0-peak). Therefore, given the restrictions on the amplitude of the high frequency voltage, when the frequency of the high frequency voltage is set to 1.5 MHz, the upper limit of the measured mass range needs to be lowered substantially compared to the case where the frequency of the high frequency voltage is set to 1.2 MHz. Namely, the measured mass range in high sensitivity mode is narrow compared to the high mass mode and has an upper limit of at most about m/z=1,500, for example. By contrast, the measurement sensitivity in high sensitivity mode is high compared to the high mass mode.

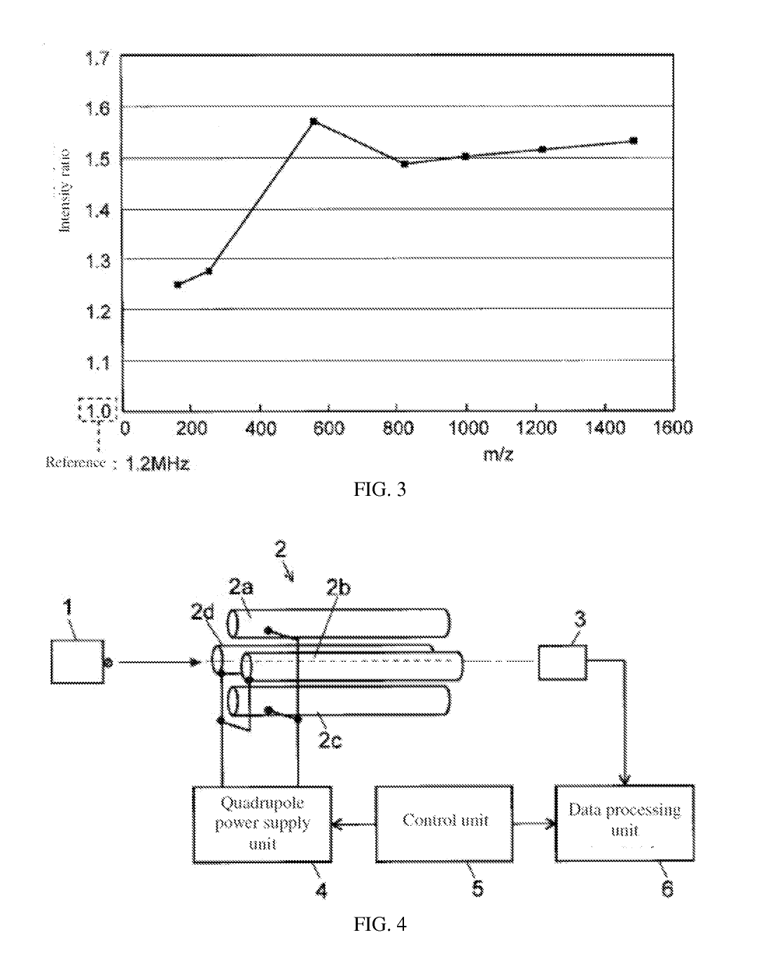

FIG. 3 is an example of embodiment in which the ion intensity is compared when the frequency of the high frequency voltage was set to 1.5 MHz and when it was set to 1.2 MHz, and shows the ion intensity at 1.5 MHz, taking ion intensity at 1.2 MHz as 1.0. It can be seen that an ion intensity of 1.2-fold or greater was obtained over a wide mass range of m/z 160 to m/z 1,500, and an ion intensity of 1.5-fold or greater was obtained in particular for high mass-charge ratios of m/z 500 or greater. It can thereby be confirmed that higher measurement sensitivity can be achieved in high sensitivity mode as compared to high mass mode.

In actually, due to variability in the inductance values of inductors 45, 46, variability of the floating capacitance value of the quadrupole mass filter 2, etc., the capacitance values of the variable capacitors 402, 403 which satisfy the LC resonance conditions will not be precisely as described above. Furthermore, the peak shape, etc. of the mass spectrum will not necessarily be the best under conditions where the Q value of the resonance is maximum. Thus, manual or automatic adjustment is performed to achieve the optimal analysis conditions, by finely adjusting the capacitance values of the variable capacitors 402, 403 through the drive sources 404, 405.

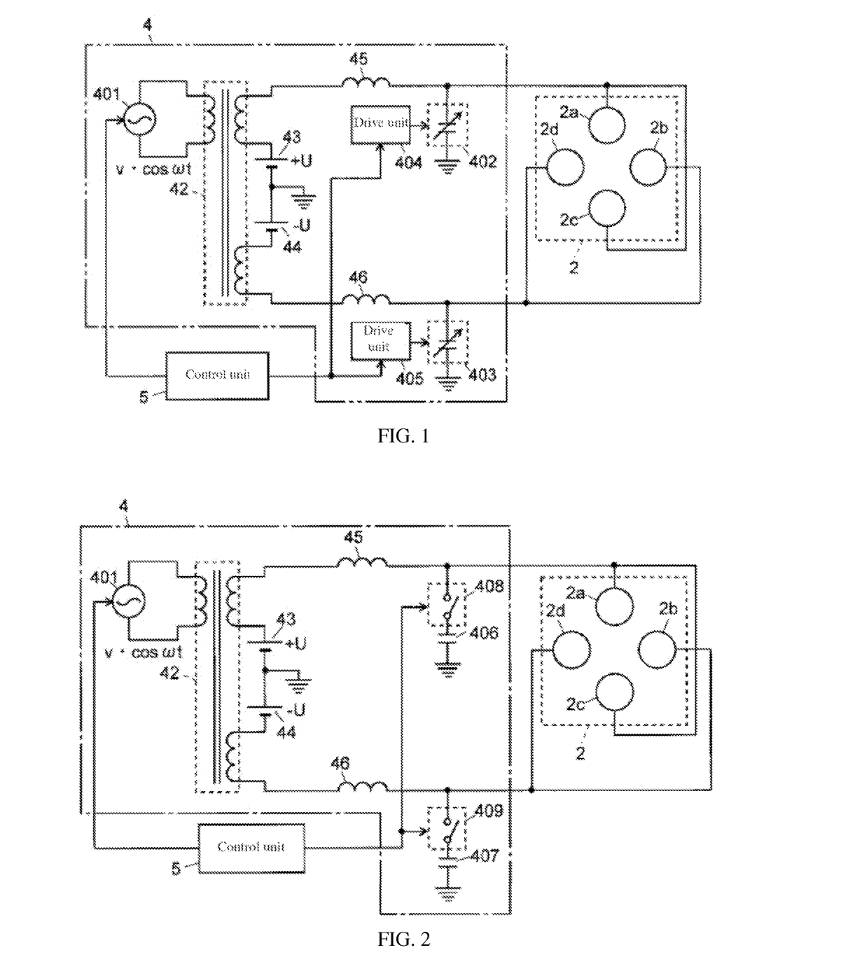

Next, a quadrupole mass spectrometry apparatus constituting another example of embodiment of the present invention (hereinafter referred to as “second example of embodiment”) will be described. The overall configuration of the quadrupole mass spectrometry apparatus of the second example of embodiment is the same as that of the conventional apparatus explained in FIG. 4, so description thereof will be omitted. A block diagram of the quadrupole power supply unit 4 is shown in FIG. 2. In the drawing, the same symbols are assigned to components identical to those described already in FIG. 1.

In the quadrupole power supply unit 4 of this second example of embodiment, capacitors 406, 407 and switches 408, 409 are provided instead of the variable capacitors 402, 403 and drive sources 404, 405 of the first example of embodiment. Namely, capacitor 406 (or capacitor 407) is connected in parallel to the floating capacitance produced by rod electrodes 2a and 2c, etc. only when switch 408 (or 409) has been turned on. Therefore, if the capacitance value of capacitor 406, 407 is set to 51 pF, the total capacitance connected in series to inductor 45 (or 46) can be switched in the same manner as in the first example of embodiment by turning switches 408 and 409 on and off, thus making it possible to suitably perform high sensitivity mode and high mass mode analysis.

However, in the case of the configuration of the second example of embodiment, fine adjustment of the capacitance value is not possible, so in order to accurately tune the LC resonant circuit or achieve the optimal tuning conditions for analysis, it is necessary to finely adjust the frequency of the high frequency voltage generated in the high frequency power supply 401.

In the examples of embodiment described above, the frequency of the high frequency voltage was switched only between two levels, but switching between three or more levels is also possible. With regard to other points as well, it is obvious that suitable modifications, corrections and additions within the gist of the present invention are included within the scope of claims of the present application.

### DESCRIPTION OF REFERENCES

1 . . . Ion source
2 . . . Quadrupole mass filter
2a through 2d . . . Rod electrodes
3 . . . Ion detector
4 . . . Quadrupole power supply unit
401 . . . High frequency power supply
402, 403 . . . Variable capacitor
404, 405 . . . Drive source
406, 407 . . . Capacitor
408, 409 . . . Switch
41 . . . High frequency power supply
42 . . . Transformer
43 . . . Positive pole direct current source
44 . . . Negative pole direct current source
45, 46 . . . Inductor
5 . . . Control unit
6 . . . Data processing unit

1. A quadrupole mass spectrometry apparatus, comprising:
a quadrupole mass filter comprising a plurality of electrodes; and
a quadrupole driving unit, comprising
a high frequency power supply unit and an inductor which increases the amplitude of the high frequency voltage supplied from said high frequency power supply unit and forms a resonant circuit along with the floating capacitance between the electrodes of said quadrupole mass filter, so as to apply, to the electrodes of said quadrupole mass filter, a predetermined voltage in which a high frequency voltage and direct current voltage are superimposed so that ions having a specific mass-charge ratio will selectively pass through said quadrupole mass filter,
wherein the output high frequency voltage of said high frequency power supply unit has a frequency which is variable or switchable between a plurality of frequencies,
a capacitor unit with a capacitance which is variable or switchable between a plurality of capacitances, connected in parallel with the floating capacitance between the electrodes of said quadrupole mass filter; and
a controller which controls said high frequency power supply unit so as to change or switch the frequency of the high frequency voltage produced by said high frequency power supply unit, and changes or switches the capacitance of said capacitor unit accordingly.

2. The quadrupole mass spectrometry apparatus as described in claim 1, wherein the frequency of the high frequency voltage produced by said high frequency power supply unit can be switched between at least two levels, and said controller, when in a sensitivity priority mode in which height of detection sensitivity is prioritized over width of measured mass range, selects a state in which the frequency of the high frequency voltage produced by said high frequency power supply unit is relatively high, and when in mass range priority mode in which width of measured mass range is prioritized over height of detection sensitivity, selects a state in which the frequency of the high frequency voltage produced by said high frequency power supply unit is relatively low.

3. The quadrupole mass spectrometry apparatus as described in claim 2, wherein said capacitor unit allows capacitance to be changed continuously.

4. The quadrupole mass spectrometry apparatus as described in claim 2, wherein said capacitor unit allows switching between a plurality of predetermined capacitances.

5. A quadrupole mass spectrometry method, comprising:
increasing the amplitude of a high frequency voltage supplied from a high frequency power supply unit by a quadrupole driving unit including a high frequency power supply unit and an inductor, wherein the quadrupole driving unit forms a resonant circuit along with the floating capacitance between electrodes of a quadrupole mass filter including a plurality of electrodes, so as to apply, to the electrodes of said quadrupole mass filter, a predetermined voltage in which a high frequency voltage and direct current voltage are superimposed so that ions having a specific mass-charge ratio will selectively pass through said quadrupole mass filter,
controlling said high frequency power supply unit so as to change or switch the frequency of an output high frequency voltage produced by said high frequency power supply unit; and
changing or switching the capacitance of a capacitor unit in accordance with the change or switch in frequency, the capacitor unit including a capacitance which is variable or switchable between a plurality of capacitances, and bring connected in parallel with the floating capacitance between the electrodes of said quadrupole mass filter.

6. The quadrupole mass spectrometry apparatus as described in claim 1,
switching the frequency of the high frequency voltage produced by said high frequency power supply unit between at least two levels, and
when in a sensitivity priority mode in which height of detection sensitivity is prioritized over width of measured mass range, selecting a state in which the frequency of the high frequency voltage produced by said high frequency power supply unit is relatively high, and
when in mass range priority mode in which width of measured mass range is prioritized over height of detection sensitivity, selecting a state in which the frequency of the high frequency voltage produced by said high frequency power supply unit is relatively low.

7. The quadrupole mass spectrometry method as described in claim 6, wherein said capacitor unit allows capacitance to be changed continuously.

8. The quadrupole mass spectrometry method as described in claim 7, wherein said capacitor unit allows switching between a plurality of predetermined capacitances.

9. The quadrupole mass spectrometry method as described in claim 5, wherein a narrow measured mass range selectively passes through said quadrupole mass filter, allowing for high detection sensitivity.

10. The quadrupole mass spectrometry method as described in claim 5, wherein a wide measured mass range selectively passes through said quadrupole mass filter, providing lower detection sensitivity.
